(19) United States
(12) Patent Application Publication
(10) Pub. No.: US 2016/0316774 A1
(43) Pub. Date: Nov. 3, 2016

(54) Automated Wax Sprayer System for Clean, Washed or Pasteurized Shell Eggs

(71) Applicant: National Pasteurized Eggs, Inc., Lansing, IL (US)

(72) Inventor: Hector Gregorio Lara, Plainfield, IL (US)

(73) Assignee: National Pasteurized Eggs, Inc., Lansing, IL (US)

(21) Appl. No.: 15/141,906

(22) Filed: Apr. 29, 2016

Related U.S. Application Data
(60) Provisional application No. 62/155,618, filed on May 1, 2015.

(51) Int. Cl. A23B 5/06

(52) U.S. Cl. CPC A23B 5/065; A23B 5/06; A23V 2002/00

(57) ABSTRACT

An automated wax sprayer system for clean, washed or pasteurized shell eggs sprays a heated solution containing water and wax emulsion onto the eggs as they rotate and pass through a conveyer. The temperature of the wax coating on the surface of the egg shells is heated at or above a sanitizing temperature and sprayed on the surface of the egg shells where Salmonella contamination may be present. Salmonella contamination present on the surface of the egg shells is eliminated substantially immediately. Separate flow pumps provide a consistent flow of wax solution to individual nozzles for consistent application of the wax on the entire surface of the eggs.

### FIELD OF THE INVENTION

The invention relates to an automated wax emulsion application system for clean, washed or pasteurized shell eggs.

### BACKGROUND OF THE INVENTION

Chicken shell eggs are susceptible to microbial contamination since the moment they are laid. Salmonella Enteritidis is known to contaminate the yolk during formation of the egg in the hen so the egg is contaminated when it is laid. Other strains of Salmonella, and other harmful bacteria, however, are believed to infect eggs primarily through the shell after the eggs are laid. For example, it is believed the primary means of contamination by Salmonella Typhimurium is migration through the shell when the pathogen is present at the farm during the sorting and grading process.

Some chicken shell eggs are washed by spraying the eggs with a solution of water and sanitizer (e.g. chlorine solution) prior to grading the eggs. Washing the eggs has the benefit of removing harmful bacteria from the outside of the shell; however, most washing techniques also remove the natural waxy cuticle on the outside of the egg shell that protects the egg from future contamination through the shell. Therefore, the processing of washed chicken shell eggs sometimes involves the application of a coating, such as oil or wax, to the eggs after washing. The purpose of the coating is to replace the natural waxy cuticle, and protect the egg from future contamination through the shell. The coating also improves shelf life.

In some shell egg operations, the eggs are not washed but separated into clean or dirty eggs. Under USDA standards, a clean egg is one in which no visible dirt or foreign material adheres to the shell. Further, small specks or stains or marks on the surface do not detract from the overall general clean appearance of the egg. Clean eggs, as defined by the USDA, may have pathogens such as Salmonella Typhimurium on the surface.

Commercial shell egg pasteurization systems submerge the eggs in a heated water bath for a long enough time to achieve a 5-log kill of Salmonella Enteritidis throughout the entire egg including the yolk and the albumen. Shell egg pasteurization focuses on Salmonella log reduction inside the egg, but care is also taken to prevent contamination through the shell after pasteurization. Methods for pasteurizing eggs are described, for example, U.S. Pat. No. 6,165,538 entitled “Pasteurized In-Shell Chicken Eggs”, by Leon John Davidson, issuing on Dec. 26, 2000 and U.S. Pat. No. 9,289,002, entitled “Shell Egg Pasteurization Method”, by Hector Gregorio Lara, issued on Mar. 22, 2016. The disclosure of both of these patents is incorporated by reference herein. The processing of the shell eggs downstream of the pasteurization bath involves spraying the eggs with an anti-bacterial agent, spraying an aqueous emulsion wax coating on the eggs, drying the coating and printing a mark on the eggs to indicate that they have been pasteurized prior to packaging in cartons or on flats.

Coating the shell after washing or submerging the egg in water, as mentioned, also improves the shelf life of the eggs. During storage, the albumen tends to thin and the air cell tends to grow due to water loss. Carbon dioxide migration through the egg shell can also lead to increased albumen pH and decreased yolk strength. Moreover, bacteria can penetrate the egg shell and cause spoilage. Low temperature refrigeration is considered an important treatment for preserving shell eggs, e.g., refrigerating at 45° F. or below. Coating the shells is another way to preserve the internal quality of the eggs. The coating forms a barrier for moisture and gas and helps prevent the penetration of bacteria or other microorganisms into the interior of the eggs. Various edible waxes or other types of coatings have been used in the past. It is known to coat the shell of washed or pasteurized chicken shell eggs with an edible coating containing wax, oil, protein or a variety of other edible ingredients in order to seal the pores in the shell and maintain freshness and quality, and extend shelf life of the egg.

One aqueous wax emulsion coating sprayed on shell eggs is an organic, combination of paraffin wax and carnauba wax. This combination when dried has been shown to provide a reliable protective coating over the shell, and also provide semi-glossy finish that is commercially desirable. The finish not only preserves the freshness of the egg and increases shelf life but also helps to maintain the safeness of the egg. The paraffin-carnauba wax emulsion requires an emulsifying agent such as morpholine oleate or other surfactant approved by the FDA for use in food coatings. An aqueous emulsion mixture (e.g., 8:1 by volume) is heated to about 160° F. and sprayed onto the eggs as a mist. In such a system, the aqueous wax emulsion solution is supplied to a spray bar and compressed air is used to spray the aqueous wax emulsion solution downward as a mist on the eggs as they pass under a spray bar. The conveyor rotates the eggs as the eggs pass through the mist so that the entire surface of the egg is covered by the coating. The eggs are then passed through a drying station prior to packaging.

The use of paraffin-carnauba wax emulsion coatings has been found to effectively maintain overall product freshness and extend shelf life in many commercial applications, especially when combined with proper refrigeration. With proper refrigeration, coated pasteurized shell eggs will normally have shelf life exceeding 60 days or even 90 days from the date of washing or pasteurization. However, current spraying technology has several deficiencies for washed or pasteurized shell eggs. First, the application of the spray to the eggs is not typically uniform and therefore a significant excess of solution is required in order to ensure that the eggs are fully covered with the wax solution. In addition, records of the waxing process to document that each batch of eggs is waxed completely and effectively are not kept. Also, the temperature and amount of the applied wax emulsion solution has not been optimized. For example, the prior art has not optimized the wax emulsion application temperature to kill Salmonella on the surface of the egg after washing.

### SUMMARY OF THE INVENTION

The invention pertains to an automated wax sprayer system and methods of coating chicken shell eggs using the automated system. The system involves several innovative aspects including the ability to heat a solution containing water and wax emulsion to or above a sanitizing temperature sufficient to reduce active Salmonella count that may be present on the shell of the chicken eggs substantially immediately on contact, e.g. in one second or less. For example, the system includes a heated mixing tank that is capable of heating the solution to a selected temperature between 175° F. and 195° F. The aqueous wax emulsion at this temperature, when sprayed onto the shells of the eggs, is kills Salmonella on the exterior of the egg and thereby reduce the active Salmonella count on the exterior of the eggs without affecting the interior quality of the eggs. At a temperature of 180° F. for example, significant Salmonella kill can be accomplished in under 0.5 seconds. The term “substantially immediately on contact” as used in the context of this invention means no longer than 2 seconds after contact, preferably no longer than 1 second after contact, and most preferably no longer than 0.5 second or less after contact. The aqueous solution is also more viscous (e.g., 5:1 by volume) which not only provides a thicker layer of protection and improves wax coverage but also helps to lengthen the amount of time that the coating holds its temperature at a level sufficient to kill Salmonella.

The system also desirably includes multiple spray nozzles that receive a metered flow of the heated solution from individual positive displacement nozzle pumps. The preferred nozzles are whirl plate, low flow, full cone spray and fog nozzles, with 120° spray angle. The positive displacement pumps are set up to discharge a calibrated, metered amount of wax emulsion solution to the individual spray nozzles. The use of dedicated positive displacement pumps enables reliable use of relatively viscous wax emulsion and water solution (e.g. 5:1), which in turn improves the ability of the wax emulsion to fully cover the surface of the egg shell. The eggs are moved through the wax station on a conveyor underneath a mist hood and are rotated on the conveyor as they are moved through the system. The metered flow from the spray nozzles overlaps to ensure full coverage of the heated wax at all locations over the shell. On contact, the heated wax emulsion, as mentioned, reduces the active Salmonella count on the shell if any is present. It may be desirable to use heated plumbing to maintain the temperature of the heated, aqueous emulsion solution as it is pumped to the spray nozzles 50. It may also be desirable to heat the space under the mist hood 34 to heat maintain the temperature of the solution as it is sprayed, although this should not be necessary in most applications. Although the wax emulsion dries quickly, it will normally be desirable to use a blower to dry the coating.

The user interface on a programmable logic controller (PLC) enables the user to set mixing speeds for the heated mixing tank, the temperature set point for the solution in the mixing tank, and the pumped aqueous wax emulsion flow rate. The user interface also enables the user to calibrate the system for applying an optimized metered amount of the wax emulsion solution. Optionally, each pump/nozzle pair can be calibrated separately from the other pump/nozzle pairs. The system also monitors the temperature of the heated solution, and the metered flow amount of solution sprayed onto the eggs. These signals are transmitted to the programmable logic controller (PLC) and are available for display in real-time on a display screen of the PLC, or for transmission to a remote computer for display. The data can also be archived on the PLC or computer and available to prepare performance reports for the automated wax station.

The automated wax sprayer system also optionally includes a sump located underneath the conveyor for collecting waste solution, and a recirculating pump for pumping waste solution from the sump back to the heated mixing tank.

The aqueous wax emulsion coating can take several forms, for example 5 parts water to one part wax emulsion comprising paraffin wax and carnauba wax. Alternatively, the edible emulsion coating described in co-pending patent application Ser. No. 15/014,353, entitled “Edible Emulsion Coating for Extended Shelf Life”, by Hector Lara, filed on Feb. 3, 2016 and incorporated herein by reference, can be used with the automated wax spray system. Further, it may be desirable to add a sanitizer to the water and wax emulsion. Sanitizers can be used to wash and/or spray the shell eggs prior to conveying the eggs through the wax station; however, that step can be eliminated by adding the sanitizer to the solution containing water and wax emulsion. Such a sanitizer may include, for example, organic sanitizers such as chlorine or hydrogen peroxide but could also include inorganic sanitizers such as quaternary ammonia.

The wax station can be used to apply wax emulsion and reduce Salmonella risk in a wide variety of egg processing applications as long as the shell eggs are not considered dirty. For example, the invention is useful to wax clean, washed, or pasteurized shell eggs, shell eggs that have been treated with RF or microwave energy, or hard boiled or soft boiled eggs in the shell.

Other features and advantages of the system may be apparent to those skilled in the art upon reviewing the following drawings and descriptions thereof.

### BRIEF DESCRIPTION OF THE DRAWINGS

FIG. 1A is a flow chart illustrating the processing of shell eggs that are spray washed and waxed prior to storage and shipping.

FIG. 1B is a flow chart illustrating the processing of pasteurized eggs prior to storage and shipping.

FIG. 2 is a perspective view of an automated wax sprayer system constructed in accordance with an exemplary embodiment of the invention.

FIG. 3 is a top plan view of the automated wax sprayer system shown in FIG. 2.

FIG. 4 is a side elevation view of the automated wax sprayer system shown in FIGS. 2 and 3.

FIG. 5 is a front elevation view of the automated wax sprayer system shown in FIGS. 2 through 4.

FIG. 6 is a flow chart illustrating the flow of information in the system to a PLC and the control of system operation via the PLC.

FIG. 7 is a partial perspective view showing shell eggs on a conveyor moving under a mist hood in the automated wax sprayer system shown in FIGS. 2 through 5.

FIG. 8 is a partial side view showing shell eggs on the conveyor being sprayed with a heated, aqueous wax emulsion solution under the mist hood in the automated wax sprayer system shown in FIGS. 2 through 5, and 7.

FIG. 9 is a partial front view showing shell eggs on the conveyor being sprayed with a heated, aqueous wax emulsion solution under the mist hood in the automated wax sprayer system shown in FIGS. 2 through 5, 7 and 8.

FIG. 10 is an example system control screen on the display of the PLC.

FIG. 11 is an example setup screen on the display of the PLC.

### DETAILED DESCRIPTION OF THE DRAWINGS

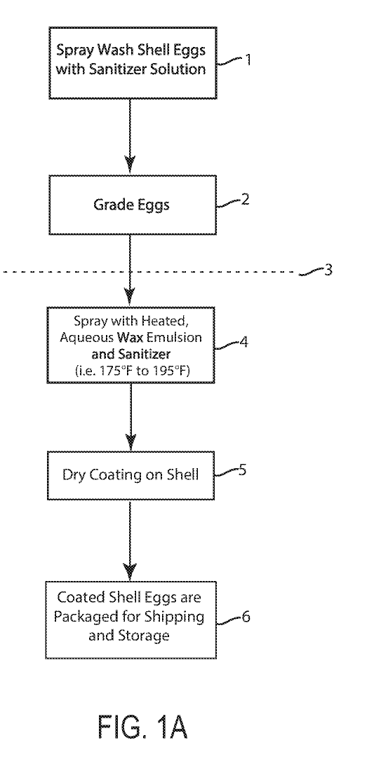

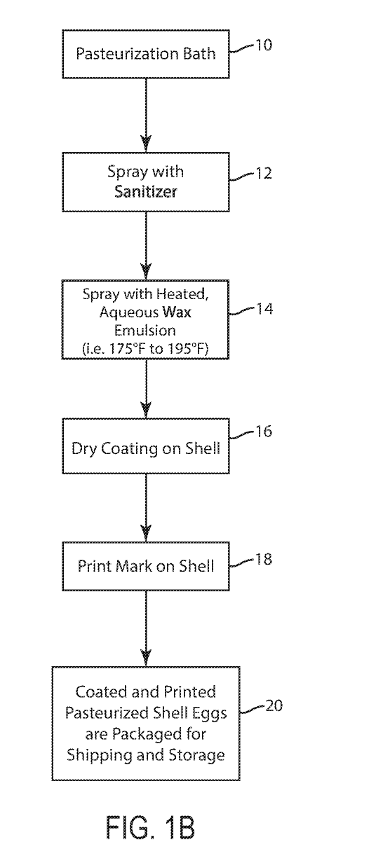

FIG. 1A shows a process for washing and waxing chicken shell eggs. Referring to block 1, the eggs are typically spray washed using a sanitizer solution, such as a water and chlorine solution. As mentioned, the washing of the eggs removes dirt and waste from the surface of the shells, but also removes the waxy cuticle on the outside of the shell. The eggs are then graded, which means separating the eggs into various sizes and grading the quality of the eggs as Grade AA, A, B or check, see block 2. It is at this point in the process, dashed line 3 in FIG. 1A, that most commercial shell eggs in the United States are packaged, sent to refrigerated storage and shipped. In other words, most washed, unpasteurized shells eggs sold in the United States are not waxed or oiled. If the eggs are to be waxed, the next step in the process is to convey the graded shell eggs to a wax spraying station, see block 4. In accordance with one aspect of the invention, the aqueous wax emulsion is heated to a temperature between 175° F. and 195° F., and is capable of reducing the active Salmonella count on the shell of the chicken eggs substantially immediately upon contact, e.g. within one second. FIG. 1A depicts that the heated aqueous wax emulsion solution includes a sanitizer in accordance with another aspect of the invention. If the heated aqueous wax emulsion solution does not include a sanitizer, then it will normally be desirable to spray wash the eggs with a sanitizer solution again after grading and before applying the aqueous wax emulsion. Next, the coating on the shells is dried, see block 5. The coated shell eggs are then packaged for shipping and storage, see block 6.

Referring to FIG. 1B, the most common commercial shell egg pasteurization process involves the placing of shell eggs in a heated water bath, block 10, for a sufficient amount of time to achieve a desired log kill of Salmonella or other bacteria. The US FDA requires that the heat treatment in the water bath be sufficient to achieve a 5-log kill of Salmonella Enteritidis. The above incorporated U.S. Pat. No. 6,165,538 entitled “Pasteurized In-Shell Chicken Eggs”, by Leon John Davidson, issuing on Dec. 26, 2000 and U.S. Pat. No. 9,289,002, entitled “Shell Egg Pasteurization Method”, by Hector Lara, issued on Mar. 2, 2016 (the “Lara '002 patent”), describe thermal treatments sufficient to achieve a 5-log kill of Salmonella Enteritidis in chicken shell eggs and should be consulted for a more complete understanding of the water bath pasteurization process. U.S. Pat. No. 6,113,961, entitled “Apparatuses and Methods for Pasteurizing In-Shell Eggs,” to Louis Polster and the above incorporated Lara '002 patent describe that is possible to stack the shell eggs in a water bath and still achieve uniform heat treatment and pasteurization. The Lara '002 patent also describes methods for accurately controlling the temperature of the water bath to ensure uniform heat treatment and pasteurization from batch to batch.

When the batches of pasteurized eggs are removed from the heated water bath 10, they are placed on a conveyor that is designed to rotate the eggs as it transports them. The first step of processing along the conveyor involves spraying the eggs with a sanitizer, see block 12, such as diluted quaternary ammonium. As mentioned above, in accordance with one aspect of the invention, this step may be optional (if sanitizer is added to the aqueous wax emulsion solution). Next, the shell eggs are sprayed with a heated and diluted, aqueous emulsion coating, see block 14. A spray station with multiple nozzles sprays the diluted, aqueous emulsion coating onto the shell eggs on the conveyor passing through the spray station. The aqueous, wax emulsion concentrate is diluted with water, for example 5:1, prior to filling the sprayer and heating the emulsion. As discussed above, the diluted emulsion is maintained at a temperature in the range of 175° F. to 195° F. in order to ensure proper application and coverage of the aqueous wax emulsion, and to reduce surface Salmonella substantially immediately on contact. After spraying the aqueous wax emulsion solution, the coated eggs enter a drying station, block 16, in which ambient air is blown over the coated eggs to dry the coating. Next, the shells are printed with a mark, see block 18, in order to identify the eggs as being pasteurized. After printing, the coated and pasteurized shell eggs are packaged and stored for shipping and distribution as indicated by block 20.

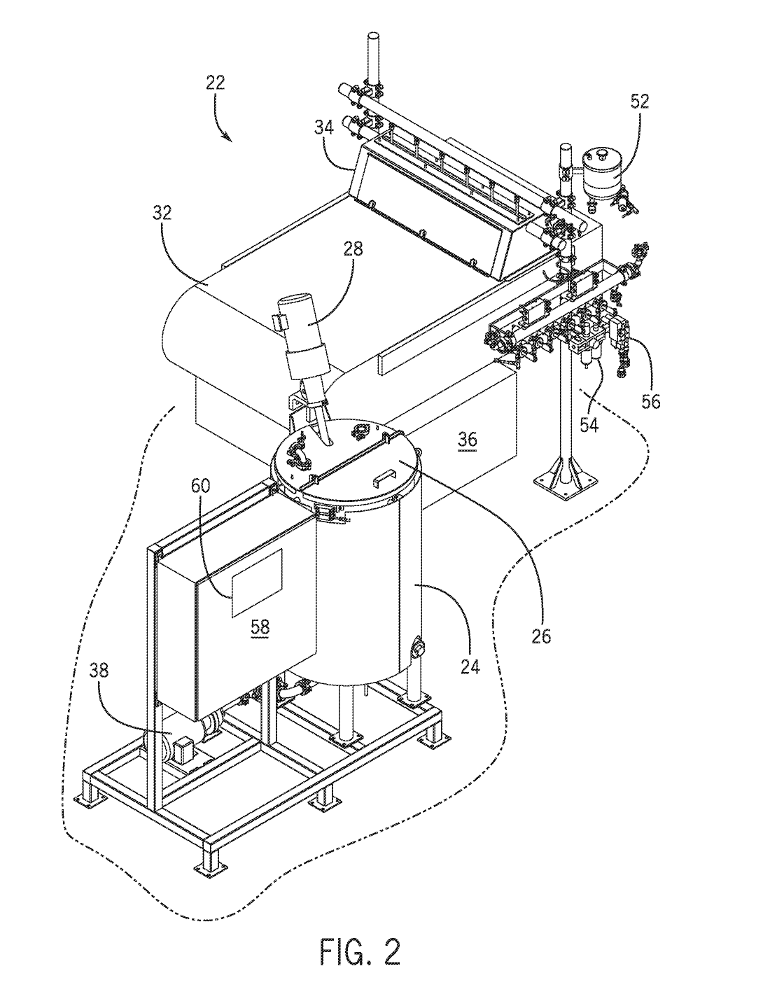

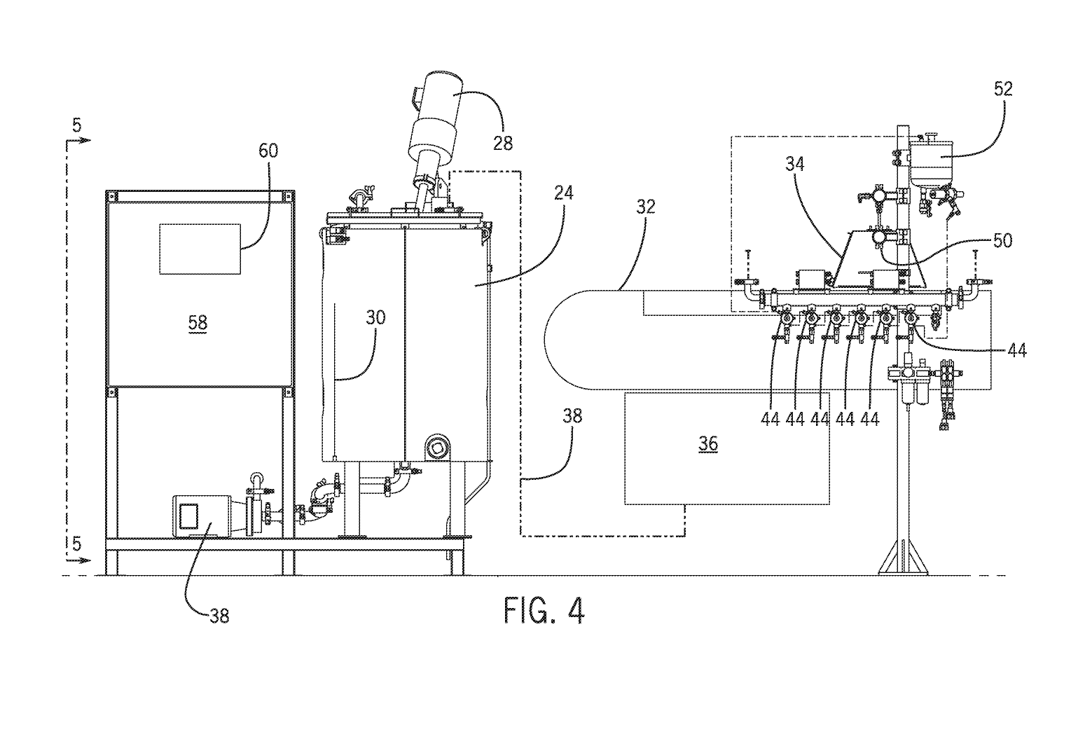

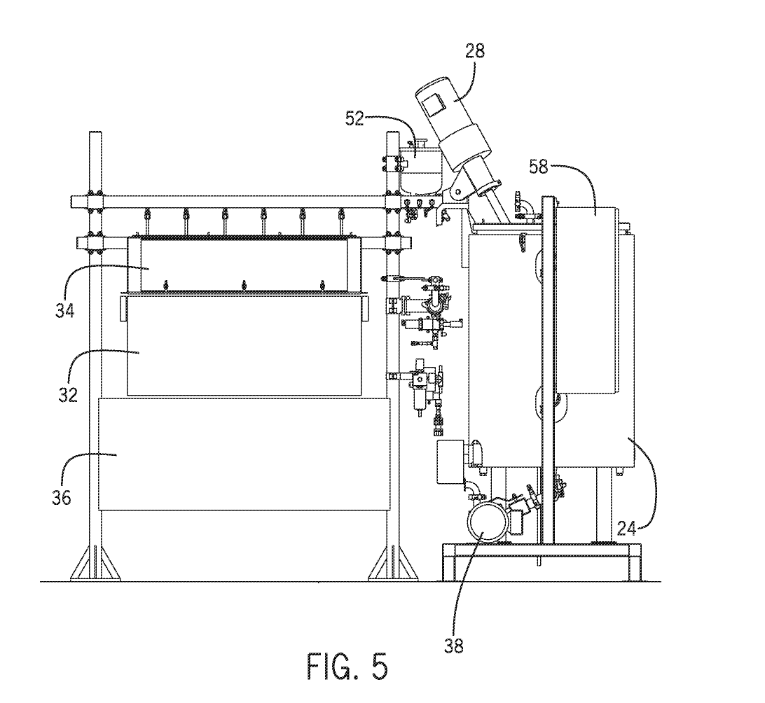

An automated wax emulsion application system 22 constructed in accordance with a preferred embodiment of the invention is illustrated in FIGS. 2 through 5. The system 22 includes a heated mixing tank 24. The tank 24 has an electrical heater in a water jacket. In this embodiment of the invention, the tank 24 is a 40 gallon stainless steel, double walled tank. The tank 24 includes a hinged lid 26 that can be opened to add water, wax emulsion constituents, and other ingredients such as sanitizer if desired. A variable speed mixer 28 is provided to mix the constituents within the tank 24. A temperature sensor 30, FIG. 4, such as an RTD is located within the mixing tank 24. Optionally, the system can also have an automated mixing pump system that mixes the water and wax emulsion in the precise selected ratio prior to adding the solution to the mixing tank 24. The optional automated mixing pump system reduces error due to human mistake. Desirably, the PLC controls pumps in the automated mixing pump system to mix the wax emulsion and water in the preselected ratio.

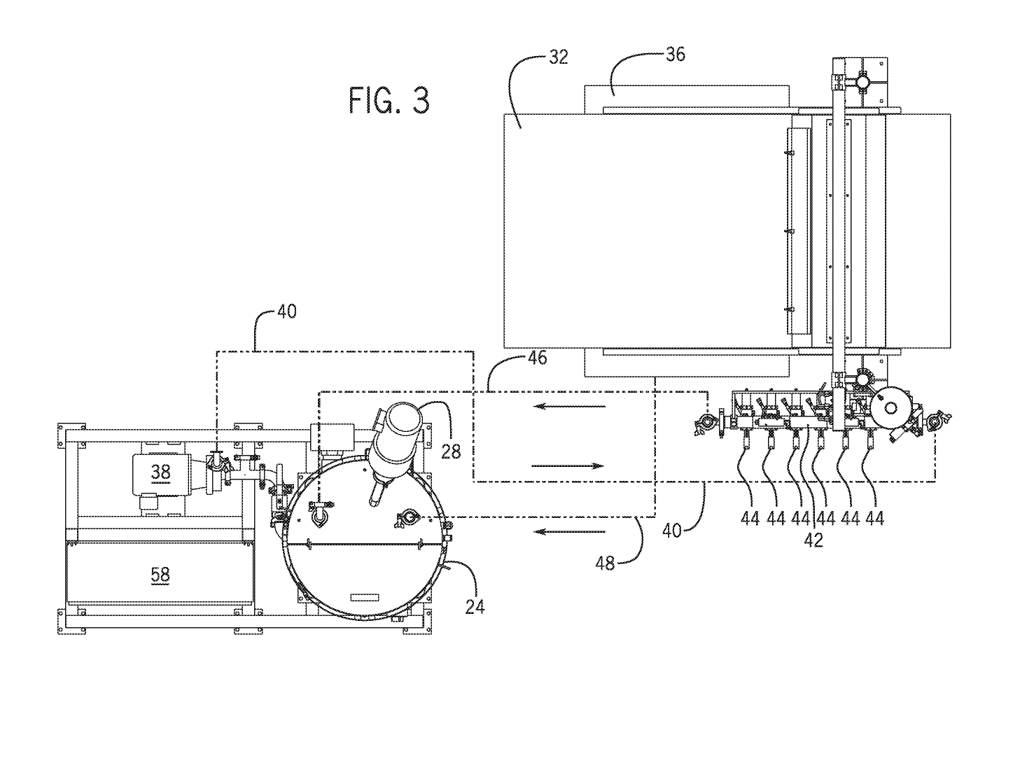

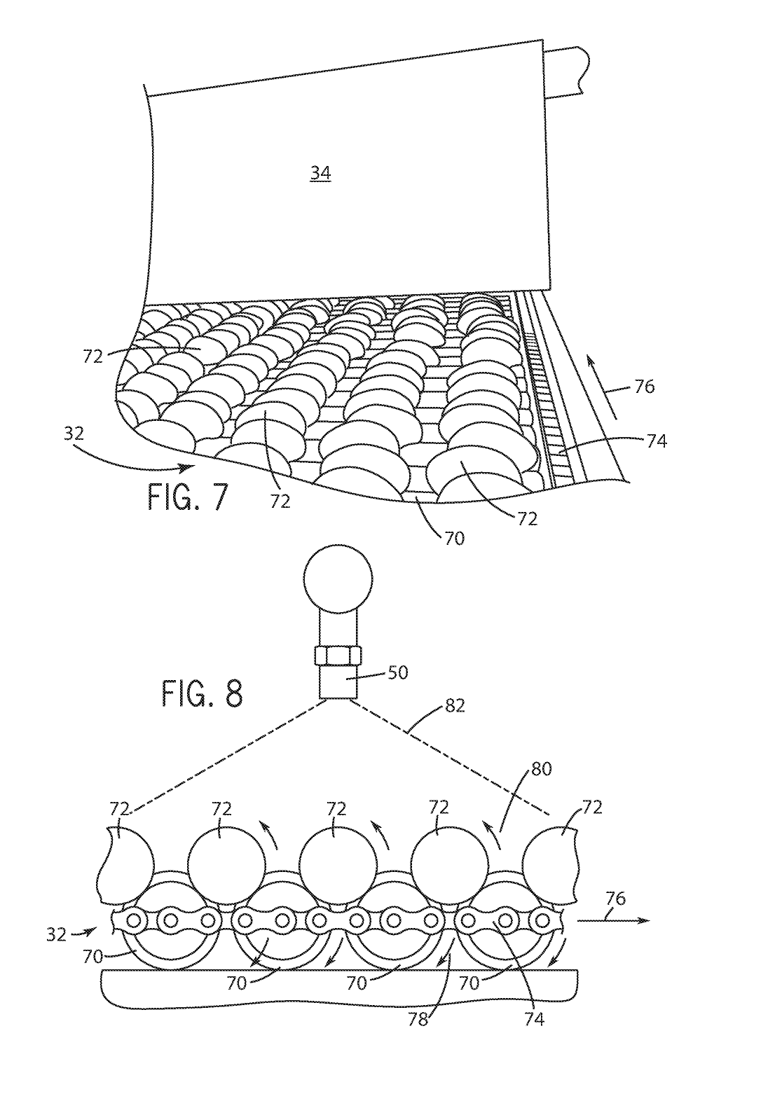

A conveyor 32 is provided to transport a layer of eggs through the spray station 22. The conveyor 32 moves the layer of eggs underneath the mist hood 34. The conveyor 32 is designed to accommodate eggs arranged in rows of 12 across the conveyor 32. The conveyor 32 rotates the eggs as the eggs move along the conveyor so that all surfaces on the shells are exposed to be sprayed with the aqueous wax emulsion solution. FIGS. 7 through 9 show components of the conveyor 32 and its operation in more detail than FIGS. 2 through 5. A sump 36 is optionally located underneath the conveyor 32. Excess solution is collected in the sump 36 and desirably returned via waste return line 48 to the mixing tank 24, see FIGS. 3 and 4.

When the automated wax emulsion application system 22 is used in connection with the pasteurization system, the egg temperature is likely to be about 110° F. when sprayed. The temperature of clean or washed eggs, on the other hand, is likely to be much lower e.g. slightly above room or ambient temperature. Even though the temperature of the wax emulsion when it is sprayed onto the surface of the eggs should be approximately 175° F. to 195° F., heat is transferred from the wax quickly to the atmosphere as the eggs are conveyed past the mist hood 34 into the ambient atmosphere and spraying the heated wax emulsion on the surface of the eggs has virtually no effect on the cloudiness of the albumen.

The system 22 includes a transfer pump 38 that pumps the aqueous wax emulsion solution from the tank 24 through supply line 40, FIG. 3, to manifold 42. Six oil flushing pumps 44 are mounted on a manifold 42. Excess emulsion solution pumped by transfer pump 38 through line 40 to manifold 42 is returned to the tank 24 via return line 46, FIG. 3. The pressure in manifold 42 should be about 5 PSIG. If the pressure is too high it will damage the pumps for the spray nozzles, on the other hand it is important for solution to completely fill the manifold 42 so that the pumps for the nozzles do not run dry. Each flow pump 44 provides a metered amount of heated solution to a respective pump nozzle 50, FIG. 4. If the wax system 22 is used to apply wax at the temperature range of 175° F. to 195° F., it may be helpful to provide appropriate insulation on the line from the heated tank 24 to the manifold 42 and flow pumps 44. It may also be important to heat the lines between the flow pumps 44 and the respective pump nozzles 50. To do this, electrically heated flex lines can be used to maintain the temperature of the liquid in the lines between the pumps and the nozzles.

Reference number 52 pertains to an oil reservoir for oil flushing the pumps 44 when necessary. The preferred nozzles 50 are whirl plate, low flow, full cone spray and fog nozzles with 120° spray angle, as mentioned previously. The positive displacement pumps 44 are programmed to discharge a calibrated, metered amount of wax emulsion solution to the individual spray nozzles 50. The calibration of the positive displacement pumps 44, and the desired micrometer setting is discussed in connection with FIG. 11. The spray pattern of the nozzles is overlapping and the wide 120° spray angle ensures that all surfaces of the shell eggs will be covered as the eggs pass under the mist hood 34 on the conveyor 32 and are rotated. Compressed air is supplied through an air filter 54 and pressure regulator 56 for operation of the flow pumps 44. The air filter 54 removes unwanted humidity in the air. It is desirable that the air pressure to the pumps 44 be adjustable.

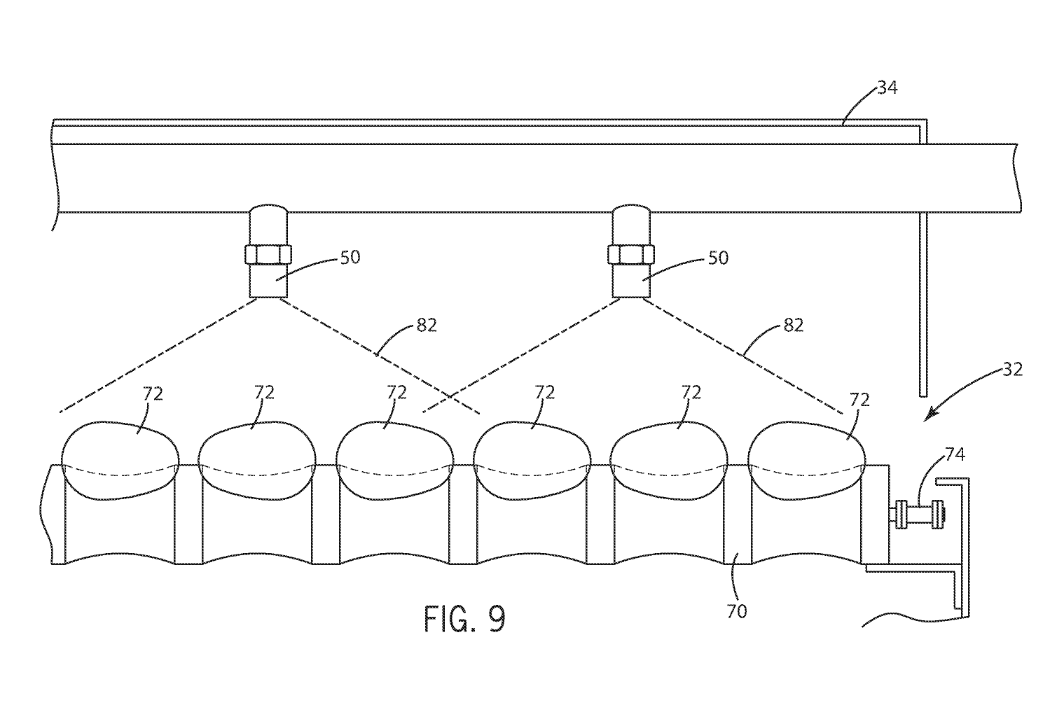

Referring to FIGS. 7 through 9 shell eggs 72 twelve across (not shown) are moved on the conveyor 32 under the mist hood 34 where the heated, aqueous wax emulsion solution is sprayed on the shell eggs 72. The conveyor rollers 70 are contoured to hold the shell eggs 72 lying on their side. Referring in particular to FIG. 8, as the rollers are moved forward in the direction of arrow 76 by the chain mechanism 74, the rollers rotate clockwise (in FIG. 8) as depicted by arrow 78. This causes the eggs 72 to spin or rotate in a counterclockwise direction as depicted by arrow 80 in FIG. 8. FIGS. 8 and 9 illustrate the spray pattern 82 of the heated, aqueous wax emulsion solution as it is sprayed from the nozzles 50, while the shell eggs 72 are moving under the mist hood 34 and rotating or spinning on the conveyor 32.

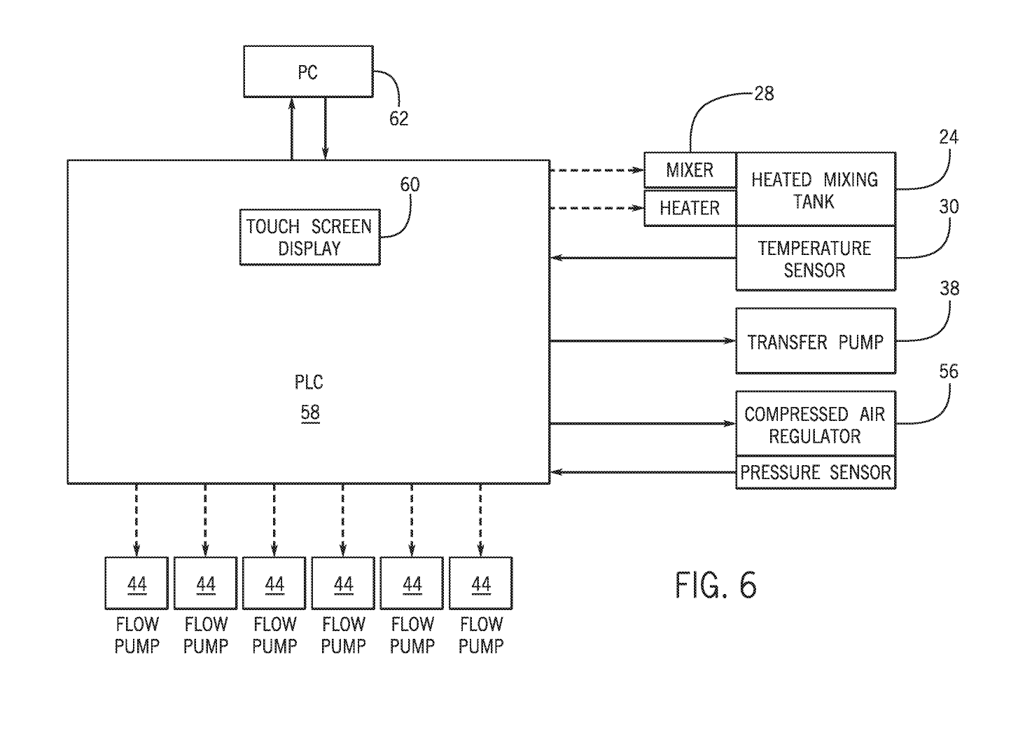

The operation of the system 22 is controlled and monitored by a programmable logic controller (PLC) 58. The PLC desirably has a touch screen display 60 which serves as a user interface for the system 22. Referring to FIG. 6, the PLC 58 includes a touch screen display 60. The PLC is programmed to send control signals (dashed arrows) to operate the flow pumps 44, the mixer 28 for the mixing tank 24, the heater for the mixing tank 24, the transfer pump 38 and optionally adjust the compressed air pressure regulator 56. As shown in FIG. 6, the PLC receives a feedback signal from the temperature sensor 30 in the heated mixing tank 24. FIG. 6 also shows that the PLC 58 is in communication with the remote PC 62. The communication with the remote PC is desirably two-way so that the system 22 can be monitored remotely and controlled remotely. In addition, as mentioned, the PLC 58 archives data regarding the settings for the flow pumps 44, and heated mixing tank 24, inasmuch as these parameters are important for insuring full and adequate coverage of the wax emulsion on the eggs being sprayed.

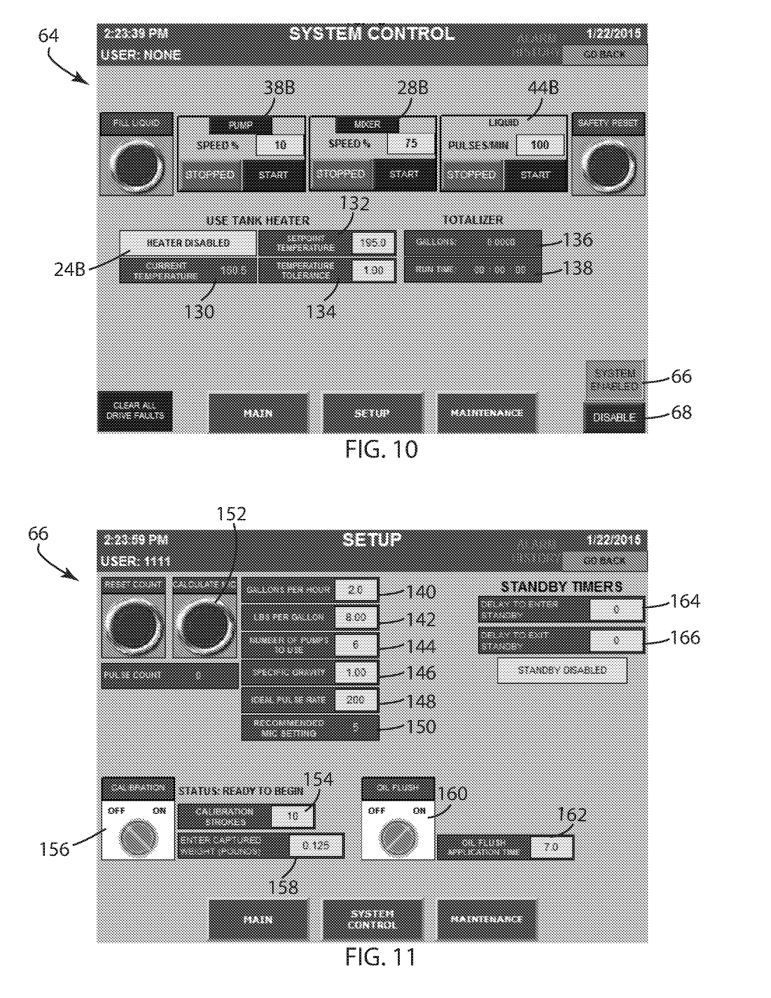

FIG. 10 depicts an exemplary screen 64 for controlling the operation of the system 22 via touch screen display 60, FIG. 6. The system is enabled or disabled using buttons 66, 68. The components of the system, namely the transfer pump 38, the mixer 28 for the mixing tank and the flow pumps 44 are started and stopped using buttons 38B, 28B and 44B respectively. The speed of the pump 38 and the mixer 28, as well as the liquid application rate by the flow pumps 44 can be adjusted using the numeric entry fields adjacent to start stop buttons 38B, 28B, 44B. The heater for the mixing tank 24 is enabled and disabled using button 24B. Field 130 in FIG. 10 shows the temperature sensed by the temperature sensor 30 in the heated mixing tank 24. Field 132 is the temperature set point which the user can set via the numeric entry field on the touch screen display 60. Field 134 is a temperature tolerance which is setable by the user. Field 136 shows the total gallons that have been used and field 138 is the total run time of the system. The totalizer tracks gallons of solution dispensed as well as the run time of the system. The accuracy of the totalizer is dependent on the information entered on the setup screen 66, see FIG. 8. The totalizer pauses during the system standby state. The accumulated values of the totalizer can be cleared by logging in with an account that has elevated privileges and pressing the reset button located next to the totalizer display. The run time totalizer 138 is important for maintenance purposes.

FIG. 11 shows the system setup screen 66. The set up screen 66 allows the user to configure the system 22. Field 140 allows the user to set the gallons per hour at a desired rate for the system. Field 142 is entered by the user as the weight per gallon of the mixed solution. Field 144 allows the user to enter the number of flow pumps 44 in use which will most likely be six if the system includes six flow pumps and six nozzles. Field 146 allows the user to enter the specific gravity of the aqueous wax emulsion solution. Field 148 allows the user to set the ideal pulse rate which is used to calculate the micrometer setting for the flow pumps 44. Field 150 is a calculation done by the system to determine the optimal micrometer setting which will achieve the target rate if the pump rate is set at the ideal pulse rate 148. Button 152 is pressed when the user is ready to calculate the recommended micrometer setting 150.

To calibrate the system 22 for accurate totalizing functionality, the desired number of calibration strokes is entered in field 154. A catch pan is used to catch solution. The calibration button 156 is pressed to initiate the calibration procedure, and the system actuates the number of strokes specified in field 154. When completed, the solution is weighed and the value is entered in window 158. Calibration is completed automatically when the weight is entered. Screen 66 also includes an oil flush button 160 which is used to lubricate and clean the pumps. Field 162 allows the user to enter the desired time in seconds for the oil flush application. Fields 164 and 166 pertain to a standby timer. The standby timer is used to set up a time delay that the system will wait to enter standby mode and a time delay the system will wait to resume normal operation.

The above drawings show one exemplary embodiment of the invention, although various aspects of the invention can be implemented alone or in combination with other features of such a system. For example, a variety of sanitizers can be added to the aqueous wax emulsion solution including organic sanitizers such as chlorine or hydrogen peroxide, or inorganic sanitizers such as quaternary ammonium. In addition, the formulation of the aqueous wax emulsion solution can be adjusted to adjust viscosity as well as the heat capacity of the wax once it is sprayed onto the egg shells. Testing and use in production has shown that the system reliably provides a relatively thick reliable layer of wax which when dried has a desirable appearance and also provides a relatively thick protective coating for the shell of the egg.

What is claimed is:

1. A method of coating a chicken shell egg comprising the steps of:
providing a wax emulsion coating spray station having a heated mixing tank, multiple spray nozzles, a conveyor for moving eggs through the spray station, a solution manifold through which heated solution from the heated tank flows to the multiple spray nozzles, and at least one pump for controlling flow through the spray nozzles;
placing shell eggs on the conveyor;
using the conveyor to move the eggs through the spray station and rotating the eggs as they progress through the spray station;
heating a solution containing water and wax emulsion in the heated tank above a sanitizing temperature sufficient to reduce an active Salmonella count that may be on the shell of the chicken eggs being coated substantially immediately;
pumping the solution of water and wax emulsion to the spray nozzles;
spraying the heated solution containing water and wax emulsion onto the eggs as they rotate and pass through the conveyer, and maintaining the temperature of the coating of wax emulsion on the surface of the shells at or above the sanitizing temperature sufficiently long to reduce Salmonella contamination that may be present on the surface of the egg shells.

2. The method as recited in claim 1 wherein the heated solution of water and wax emulsion is between substantially about 175° F. to 195° F.

3. The method as recited in claim 1 further comprising individual nozzle pumps to pump heated solution of water and wax emulsion to a respective spray nozzle.

4. The method as recited in claim 1 further comprising the steps of:
sensing the temperature of the heated solution of water and wax emulsion in the mixing tank and generating a temperature signal in response thereto;
metering the flow amount of the solution of water and wax emulsion supplied to the spray nozzles and generating a flow amount signal in response thereto; and
transmitting the temperature signal, and flow amount signal to a programmable logic controller.

5. The method as recited in claim 1 further comprising the step of providing individual displacement pumps to pump heated solution of water and wax emulsion to a respective spray nozzle, wherein the flow amount of the solution of water and wax emulsion supplied to each respective spray nozzle is metered separately and a respective flow amount signal is generated for each spray nozzle.

6. The method as recited in claim 21 wherein the heated solution also contains a sanitizer.

7. The method as recited in claim 1 further comprising the steps of:
capturing waste solution of water and wax emulsion in a sump underneath the conveyor; and
recirculating the waste solution of water and wax emulsion to the heated tank that holds the heated solution of water and wax emulsion.

8. (canceled)

9. (canceled)

10. (canceled)

11. An automated wax sprayer system comprising:
a heated mixing tank for mixing and holding a solution containing water and wax emulsion;
a conveyor to move shell eggs through the automated sprayer station and rotate the shell eggs as the eggs progress through the spray station;
a hood over the conveyor;
multiple spray nozzles that receive a metered flow of the heated solution containing water and wax emulsion and spray a mist of the heated solution generally within the hood towards the conveyor, said spray nozzles being whirl plate, full cone spray nozzles;
a solution manifold through which the heated solution is pumped to multiple spray nozzles;
a tank pump for pumping the heated solution from the heated mixing tank to the solution manifold,
individual positive displacement pumps that each pump the heated solution from the solution manifold to one of the respective spray nozzles;
a compressed air source that powers the individual pumps; and
a programmable logic controller that is programmed to control the temperature of the solution in the heated tank and the flow rate of solution pumped through the nozzles.

12. (canceled)

13. (canceled)

14. (canceled)

15. (canceled)

16. The automated wax sprayer system as recited in claim 11 further comprising:
a temperature sensor for sensing the temperature of the heated solution in the mixing tank and for generating a solution temperature signal;
means for metering the amount of solution flowing through the respective spray nozzles and generating flow signals in response thereto;
wherein the programmable logic controller receives the solution temperature signal, the flow signals and generates digital data representing solution temperature, and solution flow amounts; and the system further comprises:
a user interface that displays in real time the digital data representing the solution temperature, the solution flow rate and the air pressure.

17. The automated wax sprayer system as recited in claim 12 11 comprising six spray nozzles and six individual positive displacement pumps that pump heated solution containing water and wax emulsion to the respective spray nozzle.

18. The automated wax sprayer system as recited in claim 11 further comprising heated flow lines between the individual positive displacement pumps and the respective flow nozzles.

19. The method as recited in claim 5 further comprising the step of heating flow lines between the displacement pumps and the respective flow nozzle.

20. The method as recited in claim 1 wherein said spray nozzles are whirl plate, full cone spray nozzles.

21. The method as recited in claim 1 wherein the solution containing water and wax emulsion comprises paraffin wax and carnauba wax.

22. The method as recited in claim 1 further comprising the step of automatically mixing water and wax emulsion in a preselected ratio using a programmable mixing pump system.
